(19) United States
(12) Patent Application Publication
(10) Pub. No.: US 2014/0143271 A1
(43) Pub. Date: May 22, 2014

(54) MULTI-LEVEL MEDICAL IMAGE VIEWER MEMORY MANAGEMENT

(71) Applicant: GENERAL ELECTRIC COMPANY, Schenectady, NY (US)

(72) Inventor: Jason Dieter Klotzer, Woodside, NY (US)

(73) Assignee: General Electric Company, Schenectady, NY (US)

(21) Appl. No.: 13/683,434

(22) Filed: Nov. 21, 2012

(51) Int. Cl. G06F 17/30

(52) U.S. Cl. CPC G06F 17/3028; G06F 17/3048
USPC 707/769

(57) ABSTRACT

An example multi-level image data cache system includes a memory layer associated with a first portion of a server memory, the memory layer having a fastest access speed and least available storage space of the layers in the multi-level image data cache system. The example system includes a disk layer associated with a second portion of server memory, the memory layer having a slower access speed than the memory layer and more storage space than the memory layer. The example system includes a source layer associated with one or more locations of data storage, the source layer having a slowest access speed in comparison to the memory layer and the disk layer. In the example, a data query to the multi-level image data cache system begins by searching the memory layer followed by the disk layer and then the source layer to locate and retrieve requested image data.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Prior to the rapid onset of digital imaging, patient images were “printed” to film. The film was “hung” and viewed by radiologists, who would then dictate a report. Reports were transcribed by individuals ranging for administrative staff to medical transcriptionists and sent to ordering physician via mail or fax. Critical results were delivered by phone or pager and business statistics were managed via paper reports and spreadsheets.

As information systems for radiology came to market, the first commercially available solutions addressed the needs of the radiologist and the radiology department. These included Radiology Information Systems (RIS) and dictation transcription systems. RIS systems managed the ordering, scheduling, patient and management reporting processes while radiologists were still reading from film.

As modalities started to support the digital display of images on workstations connected to the acquisition device, Picture Archiving and Communications Systems (PACS) came to market. These centrally store images and provide radiologists with the tools to read studies on networked computer monitors, replacing both film and modality workstations.

Over time, the needs of the market have evolved from supporting specialized radiologist workflows to supporting the open and dynamic needs of the enterprise and the community. The vendor community has added systems to manage the need for advanced technologies for better diagnosis; the sharing of images between providers and organizations; to support collaboration between radiologists, physicians and teams providing care for the patient; to close the loop on reporting of critical results and manage the growing storage requirements. Often these are disparate, best-of breed systems that may or may not interoperate, increasing cost and decreasing productivity.

### BRIEF SUMMARY

Certain examples provide systems and methods for multi-layer cache storage and retrieval of medical image data.

Certain examples provide a multi-level image data cache system. The example system includes a memory layer associated with at least a first portion of a server memory, the memory layer having a fastest access speed and least available storage space of the layers in the multi-level image data cache system. The example system includes a disk layer associated with at least a second portion of the server memory, the disk layer having a slower access speed than the memory layer and more storage space than the memory layer. The example system includes a source layer associated with one or more locations of data storage, the source layer having a slowest access speed in comparison to the memory layer and the disk layer. In the example system, a data query to the multi-level image data cache system begins by searching the memory layer followed by the disk layer and then the source layer to locate and retrieve requested image data.

Certain examples provide a tangible computer-readable storage medium including computer program code to be executed by a processor, the computer program code, when executed, to implement a multi-layer image data cache system. The example multi-layer image data cache system includes a memory layer associated with at least a first portion of a server memory, the memory layer having a fastest access speed and least available storage space of the layers in the multi-level image data cache system. The example system includes a disk layer associated with at least a second portion of the server memory, the disk layer having a slower access speed than the memory layer and more storage space than the memory layer. The example system includes a source layer associated with one or more locations of data storage, the source layer having a slowest access speed in comparison to the memory layer and the disk layer. In the example system, a data query to the multi-level image data cache system begins by searching the memory layer followed by the disk layer and then the source layer to locate and retrieve requested image data.

Certain examples facilitate a method to query and retrieve image data via a multi-layer image data cache. The example method includes receiving, at the multi-layer cache, a request for image data via a medical image viewer. The example method includes searching a memory layer of the cache for the requested image data, the memory layer associated with at least a first portion of a server memory, the memory layer having a fastest access speed and least available storage space of the layers in the multi-level image data cache system. The example method includes, if the requested image data is not found in the memory layer, searching a disk layer of the cache for the requested image data, the disk layer associated with at least a second portion of the server memory, the disk layer having a slower access speed than the memory layer and more storage space than the memory layer. The example method includes, if the requested image data is not found in the disk layer, searching a source layer of the cache for the requested image data, the source layer associated with one or more locations of data storage, the source layer having a slowest access speed in comparison to the memory layer and the disk layer. The example method includes retrieving the requested image data from the layer of the multi-layer cache at which the requested image data is found and providing the requested image data to be displayed. The example method includes, if the requested image data is not found in any layer of the multi-layer cache, triggering an error.

### BRIEF DESCRIPTION OF SEVERAL VIEWS OF THE DRAWINGS

FIG. 1 illustrates an example multi-level or multi-layer cache.

FIG. 2 illustrates a flow diagram of an example method to facilitate storage of and access to data in a multi-level cache.

FIG. 3 is a block diagram of an example processor system that may be used to implement systems and methods described herein.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION OF CERTAIN EMBODIMENTS

In certain examples, a unified viewer workspace for radiologists and clinicians brings together capabilities with innovative differentiators that drive optimal performance through connected, intelligent workflows. The unified viewer workspace enables radiologist performance and efficiency, improved communication between the radiologist and other clinicians, and image sharing between and across organizations, reducing cost and improving care.

The unified imaging viewer displays medical images, including mammograms and other x-ray, computed tomography (CT), magnetic resonance (MR), ultrasound, and/or other images, and non-image data from various sources in a common workspace. Additionally, the viewer can be used to create, update annotations, process and create imaging models, communicate, within a system and/or across computer networks at distributed locations.

In certain examples, the unified viewer implements smart hanging protocols, intelligent fetching of patient data from within and outside a picture archiving and communication system (PACS) and/or other vendor neutral archive (VNA). In certain examples, the unified viewer supports image exchange functions and implements high performing streaming, as well as an ability to read across disparate PACS without importing data. The unified viewer serves as a “multi-ology” viewer, for example.

In certain examples, a native reading worklist is provided via the unified viewer. The worklist is intuitive and user defined and can include multi-identifier, multi-document, and multi-institution, for example.

Certain examples provide workflow integration via the unified viewer. Workflow integration includes integration with reporting systems, worklists, voice recognition (VR), electronic medical records (EMR); exporting of measurements; exporting of exam notes; thin slice management; etc.

In order to facilitate rapid and reliable image cache for delivery and image viewing, certain examples provide a multi-level middle tier cache. The multi-level middle tier cache divided by memory, disk, and source-stored, for example. The cache can serve as part of a middle tier server supporting a zero footprint (ZFP) viewer, for example. ZFP deployment is facilitated by this custom cache to enable a client device to quickly access images without having to retrieve them from their source each time. In the example of a ZFP middle-tier server, a multi-level cache is implemented to improve access time and reliability.

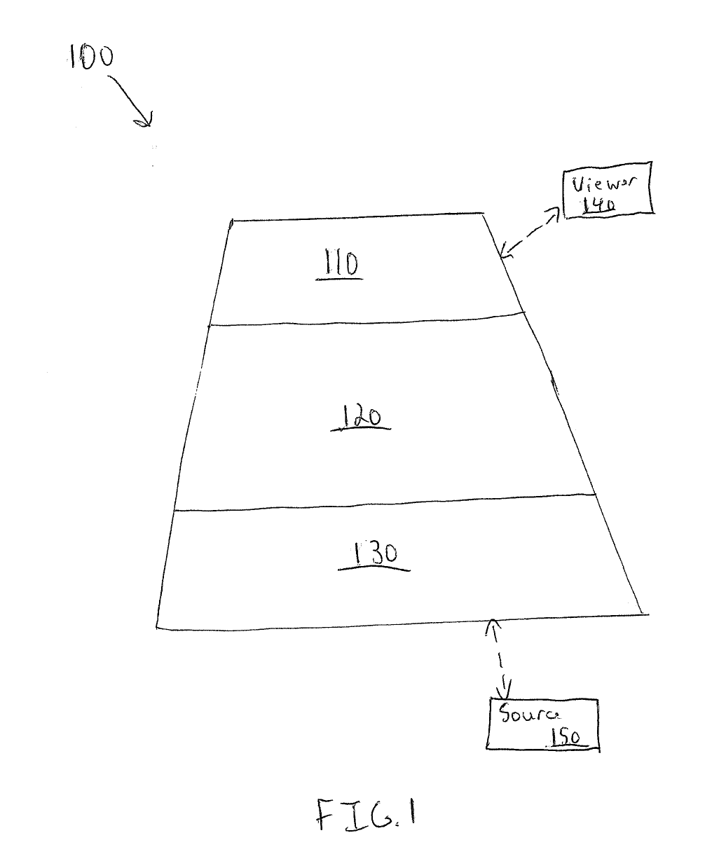

As illustrated in FIG. 1, an example multi-level or multi-layer cache 100 includes three levels: a memory layer 110, a disk layer 120, and a source layer 130.

The memory layer 110 is the fastest layer and has the least space available of the three layers in the example. For example, the memory layer 110 serves as the “main” memory or a subset of the main memory in the middle-tier server. The memory layer 110 is reserved for server cache use. The memory cache level 110 is used for data that is to be accessed immediately by an image viewer, for example. For example, the highest priority information, such as images that are currently being requested for display on the client (e.g., visible images) are stored in the immediate memory level cache.

The disk layer 120 is the middle-speed layer and has a middle or medium amount of space available compared to the other layers. The disk layer 120 is hard disk space on a server, for example. The disk layer 120 can be a page file on a ZFP middle-tier server, a memory-mapped file, etc. The disk layer 120 provides significantly slower access than the first layer 110 of the cache (immediate memory), but has much more space available. This cache level 120 is used for data that has been present on the cache 100 for a while (e.g., more than a defined threshold amount of time (e.g., a default of twenty minutes and/or otherwise configurable by user, application, client setting, etc.) (and in all likelihood, this data will not be requested anymore).

The source layer 130 is the slowest layer and represents an original location of the data. In certain examples, a pointer to the original or source data 150 is maintained in the source layer 130 in the cache 100, so that if a request comes to bring the data online, the pointer can be used to bring the data into the cache from its origin 150 (e.g., an enterprise archive, where images are originally stored by the modality, etc.). The source cache level 130 is mainly used for data that has a high improbability of being brought online, for example. However, in case the data is requested, pointers in the source cache 130 provide relatively quick access to the requested information. In certain examples, the source layer 130 is the original data store, rather than a pointer.

The multiple layers 110, 120, 130 of the cache 100 are logically organized and coordinated, even if implemented as separate physical structures, to enable correlation, searching, retrieval, update, and/or other modification at any or all levels, for example. The multiple layers 110, 120, 130 can be implemented in various combinations of RAM, memory-mapped file (MMF), external disk, and source (e.g., another server), for example.

With the implementation of the multi-level cache 100, a ZFP middle-tier server can effectively host studies of various sizes to a large number of users, for example.

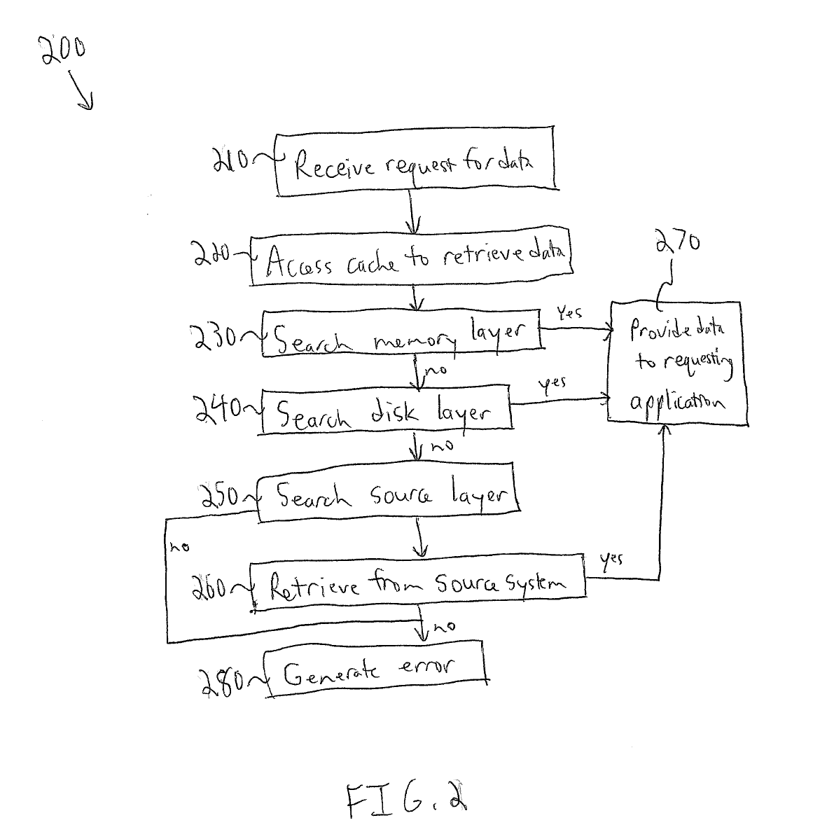

FIG. 2 illustrates a flow diagram of an example method 200 to facilitate storage of and access to data in a multi-level cache. At block 210, a request for data is received. For example, a ZFP viewer receives a request for image data and/or metadata. At block 220, the multi-layer cache 100 is accessed to retrieve the data.

At block 230, the memory layer 110 is searched to identify the requested data in the fast-access memory cache 110. If the data is found in the memory layer 110, then, at block 270, the data is provided to the requesting application.

If the requested data is not found in the memory layer 110, then, at block 240, the disk layer 120 is searched to locate the requested data. If the data is found in the disk layer 120, then, at block 270, the data is provided to the requesting application.

If the requested data is not found in the disk layer 120, then, at block 250, the source layer 130 is searched to locate the requested data. For example, the source layer 130 is searched to identify a pointer to a location containing the requested data. In most cases, for example, if the requested data is not found in the memory layer 110 or the disk layer 120 of the cache 100 on the middle-tier server, then the requested data will be found in another source system identified by a pointer in the source layer 830. At block 260, a source device is queried to retrieve the data based on a pointer in the source layer 130. At block 270, the data is provided to the requesting application. If the data is not found, at block 280, an error is generated.

For example, if an EA is the source device and indicates that some image data is available to retrieve, when in fact the data is in an offline storage (such as a Centera™ archive), the desired image data is brought online to the source system (e.g., an EA, PACS, EMR, etc.) first before it can be retrieved.

In certain examples, the multi-level middle tier cache can be used with a viewer for a zero foot print (ZFP) viewer and/or ZFP viewing. The ZFP viewer can display medical images, such as Digital Imaging and Communications in Medicine (DICOM) images, for example. In certain examples, the ZFP viewer can be implemented using Hyper Text Markup Language 5 (HTML5).

In certain examples, having zero footprint can be defined as no administrator rights or special configuration changes required to install and use the application (e.g., radiologist viewer and/or clinician viewer, etc.), providing the application to run on multiple browsers (e.g., Internet Explorer, Firefox, Safari, Chrome, etc.) and on multiple operating systems (Microsoft™ Windows, Apple OS, iOS™, Android™, etc.), providing portability to work on mobile platforms and a variety of device display sizes, require minimal or reduced computing resources (e.g., processor, memory, etc.) at the client, have acceptable performance on low bandwidth connections, etc.

The ZFP viewer can facilitate image viewing and exchange. For example, DICOM images can be viewed from a patient's longitudinal patient record in a clinical data repository, vendor neutral archive, etc. A DICOM viewer can be provided across multiple PACS databases with display of current/priors in the same framework, auto-fetching, etc.

In certain examples, the ZFP viewer is implemented based on a client framework that is able to work with multiple backend architectures. For example, a common interface, icons, annotations, terminology, tools, behaviors, etc., can be provided. An open application programming interface (API) can facilitate multiple bi-directional integrations with external systems such as reporting, EMR, VR, LDAP, etc.

Zero footprint and zero or silent deployment can be facilitated by server-side rendering of images. For example, image processing of advanced applications can occur on the server, rather than the client.

Additionally, events can be synchronization across embedded application. Logs can be generated for learning, indexing, auditing of the user activities, etc.

An example ZFP viewer is a DICOM medical image viewer that does not require any client installation or downloads of any component, and can run on virtually any hardware that is able to support an HTML5 browser (e.g., all modern hardware and operating systems).

An example middle-tier server drives conversion of image data to a format for viewing (e.g., a browser-friendly or browser-convenient format). The middle-tier server caches image data for transcoding and display via the viewer. For example, the middle-tier serve facilitates transcoding of image pixels such as transcoding between DICOM-centric compression format(s) (e.g., Joint Photographic Experts Group committee 2000 (JPEG2000) image compression and coding format, etc.) and format(s) more suitable for modern browsers (e.g., Portable Network Graphics (PNG) image format). For non-image object and meta information, the middle-tier server converts binary-based formats to browser-convenient formats, such as JavaScript Object Notation (JSON), etc.

Thus, the middle-tier server can employ transcoding to help ensure proper display of content on a diverse variety of devices. The middle-tier server provides an intermediate state of content adaptation to help ensure that source content can be displayed on a target device. In certain examples, the middle-tier server provides real-time (or near real-time) transcoding in a many-to-many format (e.g., “any” input format to “any” output format) to provide search of, display of, and interaction with image and/or other content on a variety of devices via the ZFP viewer.

Certain examples provide memory-sensitive image browsing via the ZFP viewer. For example, an amount of resources used can be tracked, and data can be paged off of the server using the multi-layer cache 100.

Certain examples provide a multi-level image cache middle tier. For example, a middle tier can be provided for data storage so as to avoid storing a large amount of information on the client side.

In certain examples, a run-time multi-level cache (e.g., memory, disk, and source) provides support for a PACS and associated viewer. A ZFP middle tier serves as a proxy for storage on a PACS and/or other data archive (e.g., an enterprise archive, etc.), for example.

A WebSocket connection, for example, serves as a primary connection to provide fast data transfer without encoding. In certain examples, Web services can facilitate data transfer for clients that do not support WebSockets. Rendering of images can be done on the server to be provided to the ZFP client, for example. In certain examples, a WebSockets-based DICOM image streaming protocol prioritizes images in order with compression to a thin-client browser and/or other ZFP HTML viewer on the client, rather than thick client to thick client streaming.

In certain examples, a data manager is provided on a server. The data manager on the server performs data compression and transcoding of data to be sent to a client viewer. In certain examples, the data manager includes a non-image object converter to convert non-DICOM object to usable format.

In certain examples, “memory sensitive” image browsing is facilitated by tracking an amount of resources used and paging requested image data off of the server to send to the browser. In addition to keeping track of an amount of memory used, a receiving client device is analyzed to determine whether the client device is capable of processing a given type of image, for example.

Additionally, form factor-based streaming technology provides, based on available client device characteristics including size (form factor), an initial image compressed at a first resolution for viewing while a full lossless medical diagnostic quality image is downloaded in the background. In certain examples, by accounting for a client device's form factor when streaming image data, images can be rendered on the server for delivery to and display on a device that are specific to the size and/or other characteristic of the device.

For example, if the client device is a handheld or mobile device (e.g., a smart phone, a tablet computer, etc.) and a mammography image (e.g., 8-10 megabytes in size) is selected for display, the user will not typically be able to view the image in a timely manner on the device. However, by facilitating communication between the client device and the server, the client can provide the server with a desired display port size, and the server can create a progressively compressed resolution image. The resulting image can be sent to the client to be displayed in a lowest resolution for the viewport size on the client. The remainder of the data for the image can be transmitted to the client in the background while the user is viewing the lower resolution image on the client device. Thus, a user flexibly receives an appropriate resolution for a type of client device being used to display the image.

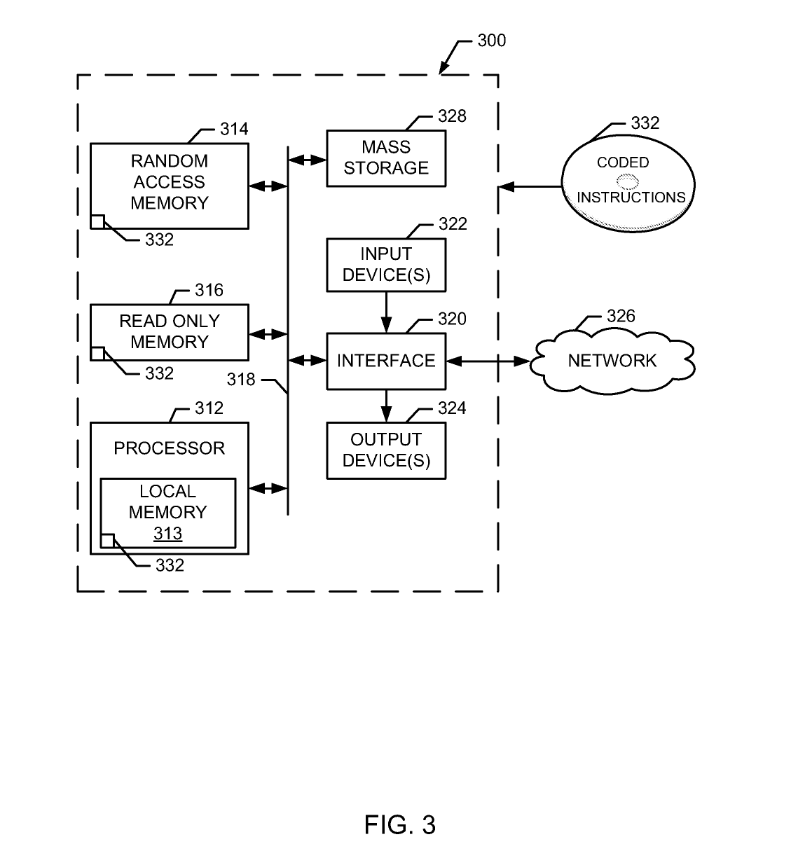

FIG. 3 is a block diagram of an example processor system 310 that may be used to implement systems and methods described herein. As shown in FIG. 3, the processor system 310 includes a processor 312 that is coupled to an interconnection bus 314. The processor 312 may be any suitable processor, processing unit, or microprocessor, for example. Although not shown in FIG. 3, the system 310 may be a multi-processor system and, thus, may include one or more additional processors that are identical or similar to the processor 312 and that are communicatively coupled to the interconnection bus 314.

The processor 312 of FIG. 3 is coupled to a chipset 318, which includes a memory controller 320 and an input/output (“I/O”) controller 322. As is well known, a chipset typically provides I/O and memory management functions as well as a plurality of general purpose and/or special purpose registers, timers, etc. that are accessible or used by one or more processors coupled to the chipset 318. The memory controller 320 performs functions that enable the processor 312 (or processors if there are multiple processors) to access a system memory 324 and a mass storage memory 325.

The system memory 324 may include any desired type of volatile and/or non-volatile memory such as, for example, static random access memory (SRAM), dynamic random access memory (DRAM), flash memory, read-only memory (ROM), etc. The mass storage memory 325 may include any desired type of mass storage device including hard disk drives, optical drives, tape storage devices, etc.

The I/O controller 322 performs functions that enable the processor 312 to communicate with peripheral input/output (“I/O”) devices 326 and 328 and a network interface 330 via an I/O bus 332. The I/O devices 326 and 328 may be any desired type of I/O device such as, for example, a keyboard, a video display or monitor, a mouse, etc. The network interface 330 may be, for example, an Ethernet device, an asynchronous transfer mode (“ATM”) device, an 802.11 device, a DSL modem, a cable modem, a cellular modem, etc. that enables the processor system 310 to communicate with another processor system.

While the memory controller 320 and the I/O controller 322 are depicted in FIG. 3 as separate blocks within the chipset 318, the functions performed by these blocks may be integrated within a single semiconductor circuit or may be implemented using two or more separate integrated circuits.

It should be understood by any experienced in the art that the inventive elements, inventive paradigms and inventive methods are represented by certain exemplary embodiments only. However, the actual scope of the invention and its inventive elements extends far beyond selected embodiments and should be considered separately in the context of wide arena of the development, engineering, vending, service and support of the wide variety of information and computerized systems with special accent to sophisticated systems of high load and/or high throughput and/or high performance and/or distributed and/or federated and/or multi-specialty nature.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A multi-level image data cache system comprising:
a memory layer associated with at least a first portion of a server memory, the memory layer having a fastest access speed and least available storage space of the layers in the multi-level image data cache system;
a disk layer associated with at least a second portion of the server memory, the disk layer having a slower access speed than the memory layer and more storage space than the memory layer; and
a source layer associated with one or more locations of data storage, the source layer having a slowest access speed in comparison to the memory layer and the disk layer,
wherein a data query to the multi-level image data cache system begins by searching the memory layer followed by the disk layer and then the source layer to locate and retrieve requested image data.

2. The system of claim 1, wherein the memory layer is to be reserved for storage and access by an image viewer.

3. The system of claim 1, wherein the at least a second portion of the server memory for the disk layer comprises hard disk space on the server.

4. The system of claim 1, wherein the disk layer comprises at least one of a page file and a memory-mapped file on the server.

5. The system of claim 1, wherein data is to be moved from the memory layer into the disk layer after the data has been present in the cache for more than a defined threshold amount of time.

6. The system of claim 1, wherein the source layer comprises a plurality of pointers to storage locations of image data.

7. The system of claim 7, wherein a query for image data at the source layer retrieves the image data from the storage location based on a pointer in the source layer and brings the data into the cache system.

8. The system of claim 1, wherein the server comprises a middle-tier server facilitating zero footprint image viewing and manipulation in conjunction with a zero footprint image viewer and a web client.

9. A tangible computer-readable storage medium including computer program code to be executed by a processor, the computer program code, when executed, to implement a multi-layer image data cache system comprising:
a memory layer associated with at least a first portion of a server memory, the memory layer having a fastest access speed and least available storage space of the layers in the multi-level image data cache system;
a disk layer associated with at least a second portion of the server memory, the disk layer having a slower access speed than the memory layer and more storage space than the memory layer; and
a source layer associated with one or more locations of data storage, the source layer having a slowest access speed in comparison to the memory layer and the disk layer,
wherein a data query to the multi-level image data cache system begins by searching the memory layer followed by the disk layer and then the source layer to locate and retrieve requested image data.

10. The computer-readable storage medium of claim 9, wherein the memory layer is to be reserved for storage and access by an image viewer.

11. The computer-readable storage medium of claim 9, wherein the at least a second portion of the server memory for the disk layer comprises hard disk space on the server.

12. The computer-readable storage medium of claim 9, wherein the disk layer comprises at least one of a page file and a memory-mapped file on the server.

13. The computer-readable storage medium of claim 9, wherein data is to be moved from the memory layer into the disk layer after the data has been present in the cache for more than a defined threshold amount of time.

14. The computer-readable storage medium of claim 9, wherein the source layer comprises a plurality of pointers to storage locations of image data.

15. The computer-readable storage medium of claim 14, wherein a query for image data at the source layer retrieves the image data from the storage location based on a pointer in the source layer and brings the data into the cache system.

16. The computer-readable storage medium of claim 9, wherein the server comprises a middle-tier server facilitating zero footprint image viewing and manipulation in conjunction with a zero footprint image viewer and a web client.

17. A method to query and retrieve image data via a multi-layer image data cache, the method comprising:
receiving, at the multi-layer cache, a request for image data via a medical image viewer;
searching a memory layer of the cache for the requested image data, the memory layer associated with at least a first portion of a server memory, the memory layer having a fastest access speed and least available storage space of the layers in the multi-level image data cache system;
if the requested image data is not found in the memory layer, searching a disk layer of the cache for the requested image data, the disk layer associated with at least a second portion of the server memory, the disk layer having a slower access speed than the memory layer and more storage space than the memory layer;
if the requested image data is not found in the disk layer, searching a source layer of the cache for the requested image data, the source layer associated with one or more locations of data storage, the source layer having a slowest access speed in comparison to the memory layer and the disk layer;
retrieving the requested image data from the layer of the multi-layer cache at which the requested image data is found and providing the requested image data to be displayed; and
if the requested image data is not found in any layer of the multi-layer cache, triggering an error.

18. The method of claim 17, further comprising moving data from the memory layer into the disk layer after the data has been present in the cache for more than a defined threshold amount of time.

19. The method of claim 17, wherein the source layer comprises a plurality of pointers to storage locations of image data.

20. The method of claim 19, wherein a query for image data at the source layer retrieves the image data from the storage location based on a pointer in the source layer and brings the data into the cache system.
